(19) United States
(12) Patent Application Publication
(10) Pub. No.: US 2026/0074263 A1
(43) Pub. Date: Mar. 12, 2026

(54) SECONDARY BATTERY MANUFACTURING APPARATUS AND METHOD

(71) Applicant: SK On Co., Ltd., Seoul (KR)

(72) Inventors: Young Ki HONG, Daejeon (KR); Do Eon LEE, Daejeon (KR); Chang Beom HA, Daejeon (KR)

(21) Appl. No.: 19/321,548

(22) Filed: Sep. 8, 2025

(30) Foreign Application Priority Data
Sep. 6, 2024 (KR) 10-2024-0121245

(51) Int. Cl. H01M 10/04; F26B 21/00; H01M 4/04

(52) U.S. Cl. CPC H01M 10/0404; F26B 21/50; H01M 4/0471

(57) ABSTRACT

A secondary battery manufacturing apparatus and method are disclosed. The apparatus including: an air supply duct through which a flow of drying air is guided in a first direction; and a drying trunk connected to the air supply duct to guide the flow of the drying air in a second direction intersecting the first direction, wherein the air supply duct includes a plurality of air supply vanes, the drying trunk includes a plurality of drying vanes, the plurality of air supply vanes distribute the drying air and guide the flow of the drying air in a width direction of the air supply duct, and the plurality of drying vanes distribute the drying air and guide the flow of the drying air in a width direction of the drying trunk.

### CROSS-REFERENCE TO RELATED APPLICATION

This application claims priority to and the benefit of Korean Patent Application No. 10-2024-0121245, filed on Sep. 6, 2024, the disclosure of which is incorporated herein by reference in its entirety.

### BACKGROUND

### 1. Field of the Invention

Embodiments of the present disclosure relate to a secondary battery manufacturing apparatus and method.

### 2. Discussion of Related Art

A secondary battery is one of energy storage means which can be charged and discharged through electrochemical reactions. The secondary battery is widely used in various fields in which electrical energy is used. For example, secondary batteries are widely utilized in mobile devices such as a cell phone, a notebook, a tablet, and the like, and are being explored for wider utilization in the field of transportation means such as vehicles, aircraft, ships, and the like. Further, demand for secondary batteries is rapidly increasing in the field of energy storage systems (ESSs) for utilizing surplus electricity.

An electrode of the secondary battery may be manufactured by applying a positive electrode active material or negative electrode active material to a current collector. The current collector may be provided in the form of a metal foil, and the active material may be mixed with a conductive material or the like and applied to the current collector in the form of a slurry. The applied active material may undergo a drying process. Generally, the drying of the electrode may be performed through a method of supplying heated air through an electric heater, a gas boiler, or the like to an outer surface of the electrode on which the active material is applied.

The drying of the electrode may be performed by a process of rapidly drying a thin solution of a few millimeters or less, and appropriate drying of the electrode may directly affect the surface defects of products, production yield, or the like. However, recently, the electrode is gradually becoming larger to enhance energy density or the like, which causes uniform drying of the electrode to be difficult. For example, a thicker coated electrode or a wider electrode may cause a drying variation between a deep portion and a surface portion or between a central region and an edge region. Further, in terms of drying equipment, a difference in an amount of airflow provided to each region may appear depending on an operating state of the equipment. For example, depending on the magnitude of the provided airflow, a region where the airflow is concentrated may appear differently, which may cause a drying deviation for each region of the electrode.

### SUMMARY OF THE INVENTION

Some embodiments of the present disclosure may provide a secondary battery manufacturing apparatus and method which may be used to dry an electrode.

Further, some embodiments of the present disclosure may provide a secondary battery manufacturing apparatus and method capable of improving the processing quality of an electrode and reducing manufacturing unit costs.

At least some embodiments of the present disclosure may be widely applied in the field of green technologies such as an electric vehicle and a battery charging station as well as solar power generation and wind power generation using batteries. Further, at least some embodiments of the present disclosure may be used in an eco-friendly electric vehicle, a hybrid vehicle, and the like to prevent climate change by suppressing air pollution and greenhouse gas emissions.

According to an aspect of the present disclosure, there is provided a secondary battery manufacturing apparatus including: an air supply duct that guides a flow of drying air in a first direction; and a drying trunk connected to the air supply duct to guide the flow of the drying air in a second direction intersecting the first direction and supply the drying air to an electrode at a bottom thereof, wherein the air supply duct includes a plurality of air supply vanes that partition a plurality of air supply flow paths, the drying trunk includes a plurality of drying vanes that partition a plurality of drying flow paths to correspond to the plurality of air supply flow paths, the plurality of air supply vanes distribute the drying air and guide the flow of the drying air in a width direction of the air supply duct intersecting the first direction, and the plurality of drying vanes distribute the drying air and guide the flow of the drying air in a width direction of the drying trunk intersecting the second direction.

In some embodiments, the plurality of air supply vanes may be formed to distribute a flow rate of the drying air with a deviation along the width direction of the air supply duct.

In some embodiments, the plurality of air supply vanes may be formed to distribute a relatively small amount of the drying air to an edge-side air supply flow path corresponding to a widthwise edge of the electrode.

In some embodiments, the plurality of air supply flow paths may include an edge-side air supply flow path corresponding to a widthwise edge of the electrode, and the edge-side air supply flow path may be formed with a smaller inlet size than an air supply flow path disposed at a center.

In some embodiments, one or more of the plurality of air supply vanes may include a movable air supply vane formed to change an inlet width of the corresponding air supply flow path.

In some embodiments, the movable air supply vane may be formed to change the inlet width of the air supply flow path by moving a movable end in a circumferential direction around a rotation axis.

In some embodiments, the electrode may be dried under the drying trunk while traveling in the second direction.

In some embodiments, each of the plurality of drying vanes may be formed to extend a certain length from the corresponding air supply vane in the width direction of the drying trunk.

In some embodiments, the plurality of drying vanes may be formed to extend to have different lengths in the width direction of the drying trunk, and the plurality of drying flow paths may be partitioned by the plurality of drying vanes to have the same width in the width direction of the drying trunk.

In some embodiments, one or more of the plurality of drying vanes may include a first direction-changing portion at an end portion, and the first direction-changing portion may change the direction of the drying air guided to flow in the width direction of the drying trunk to the second direction and guide the flow.

In some embodiments, the secondary battery manufacturing apparatus may include an edge vane formed to extend from one side duct sidewall of the air supply duct in the width direction of the drying trunk, wherein each of the plurality of drying vanes may include a first direction-changing portion at an end portion, the first direction-changing portion may extend in a curved manner in a backward direction along the second direction, the edge vane may include a second direction-changing portion at an end portion, and the second direction-changing portion may extend in a curved manner in a forward direction along the second direction.

In some embodiments, any one or more of the plurality of drying vanes may include an opening that connects adjacent drying flow paths, and the opening may include a movable drying vane that adjusts an opening degree of the opening.

In some embodiments, the movable drying vane may include first and second movable ends disposed with a rotation axis therebetween, and may be formed so that the first and second movable ends move and change the opening degree of the opening as the movable drying vane is rotated around the rotation axis.

In some embodiments, the movable drying vane may be formed to adjust the opening degree of the opening and distribute a flow rate of the drying air between the adjacent drying flow paths.

In some embodiments, wherein each of the drying vanes may include: a first extending portion extending in the width direction of the drying trunk; a first direction-changing portion extending in a curved manner from an end portion of the first extending portion to change the direction of the drying air to the second direction; and a second extending portion formed to extend from an end portion of the first direction-changing portion in a backward direction along the second direction.

In some embodiments, the movable drying vane may be disposed in the first extending portion of the corresponding drying vane.

According to another aspect of the present disclosure, there is provided a secondary battery manufacturing method including: (a) an operation of guiding drying air to flow through an air supply duct in a first direction; (b) an operation of guiding the drying air to flow through a drying trunk in a second direction intersecting the first direction; and (c) an operation of supplying the drying air to an electrode traveling in the second direction, wherein operation (a) includes an operation in which a plurality of air supply flow paths are partitioned in a width direction of the air supply duct intersecting the first direction, and the drying air is distributed and guided to flow into the plurality of air supply flow paths, and operation (b) includes an operation in which a plurality of drying flow paths are partitioned in a width direction of the drying trunk intersecting the second direction, and the drying air is distributed and guided to flow into the plurality of drying flow paths.

In some embodiments, operation (a) may include distributing a relatively small amount of the drying air to an edge-side air supply flow path corresponding to a widthwise edge of the electrode, and operation (b) may include distributing a relatively small amount of the drying air to an edge-side drying flow path corresponding to a widthwise edge of the electrode according to the distribution of the drying air.

In some embodiments, the air supply duct may include a plurality of air supply vanes that partition the plurality of air supply flow paths, and one or more of the plurality of air supply vanes may include a movable air supply vane formed to change an inlet width of the corresponding air supply flow path.

In some embodiments, the drying trunk may include a plurality of drying vanes that partition the plurality of drying flow path, and one or more of the plurality of drying vanes may include a movable drying vane formed to distribute a flow rate of the drying air between adjacent drying flow paths.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1A is a schematic plan view of a secondary battery manufacturing apparatus according to an embodiment of the present disclosure;

FIG. 1B is a schematic front view of the secondary battery manufacturing apparatus shown in FIG. 1A;

FIG. 2 is a partially enlarged view of the secondary battery manufacturing apparatus shown in FIG. 1;

FIG. 3 is an exemplary operating state diagram of the secondary battery manufacturing apparatus shown in FIG. 1;

FIG. 4A is a schematic diagram showing the operating state of an air supply duct shown in FIG. 3;

FIG. 4B is a schematic diagram showing the air supply duct as seen in the direction of E1 in FIG. 4A;

FIG. 5 is a schematic graph showing an amount of heat supply along a width direction of an electrode in the operating state shown in FIG. 3;

FIG. 6 is a conceptual diagram showing a secondary battery manufacturing apparatus according to another embodiment of the present disclosure; and

FIG. 7 is a schematic graph showing an amount of heat supply along a width direction of an electrode in the secondary battery manufacturing apparatus shown in FIG. 6.

### DETAILED DESCRIPTION OF EXEMPLARY EMBODIMENTS

Hereinafter, the present disclosure will be described in detail with reference to the accompanying drawings. However, this is merely exemplary, and the present disclosure is not limited to the exemplified specific embodiments.

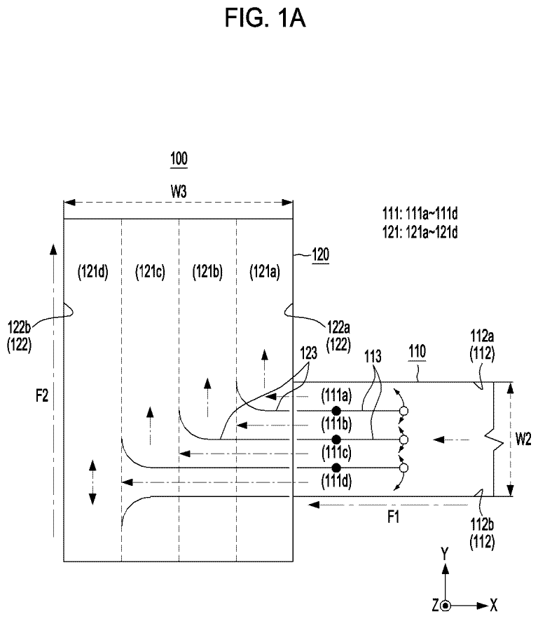

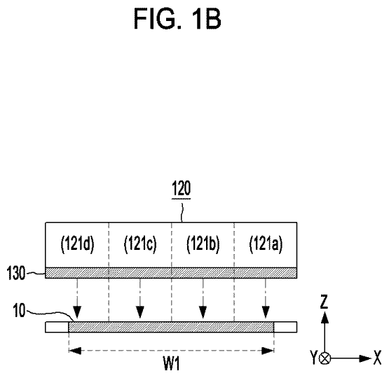

FIG. 1A is a schematic plan view of a secondary battery manufacturing apparatus according to an embodiment of the present disclosure. FIG. 1B is a schematic front view of the secondary battery manufacturing apparatus shown in FIG. 1A.

For convenience of description, an x-axis direction is referred to as a left-right direction, a y-axis direction is referred to as a front-back direction, and a z-axis direction is referred to as an up-down direction based on coordinate axes shown in FIG. 1.

Referring to FIGS. 1A and 1B, in some embodiments, a secondary battery manufacturing apparatus 100 may be used to dry an electrode 10. The electrode 10 may be provided in a sheet form having a certain left-right width W1. The electrode 10 may be formed to extend in a longitudinal direction (the front-back direction), and may be transported in the front-back direction with respect to the secondary battery manufacturing apparatus 100 and dried.

The electrode 10 may be provided in the form of a flexible sheet having a thin thickness. For example, the electrode 10 may be provided in the form of a flexible sheet having a thickness of a several millimeters or less. However, the scope of use of the secondary battery manufacturing apparatus 100 is not limited to the exemplified thickness.

In some embodiments, the electrode 10 may be provided by coating a slurry type active material on a metal foil which functions as a current collector. The secondary battery manufacturing apparatus 100 may be used to dry the coated active material. The electrode 10 may include a positive electrode or negative electrode, and the current collector and the active material may include various known current collectors and active materials. In the present disclosure, detailed components such as the current collector, the active material, and the like which constitute the electrode 10 are not specifically limited.

In some embodiments, the active material may be coated on the current collector in a multi-row structure. For example, the active material may be provided so that a plurality of active material bands each having a certain left-right width are disposed spaced apart in the left-right direction on the current collector. However, in addition to this, the active material may be coated on the current collector with various structures, shapes, arrangements, and the like, and a specific coating form of the active material is not specifically limited in the present disclosure.

In some embodiments, the secondary battery manufacturing apparatus 100 may include an air supply duct 110 through which the drying air is guided to flow in a first direction F1, and a drying trunk 120 which is connected to the air supply duct 110 so that the drying air is guided to flow in a second direction F2 intersecting the first direction F1, and supplies the drying air to the electrode 10 therebelow. Here, the air supply duct 110 may include a plurality of air supply vanes 113 which partition a plurality of air supply flow paths 111, and the drying trunk 120 may include a plurality of drying vanes 123 which partition a plurality of drying flow paths 121 to correspond to the plurality of air supply flow paths 111. Further, the plurality of air supply vanes 113 may distribute the drying air and guide the flow of the drying air in the width direction of the air supply duct 110 intersecting the first direction F1, and the plurality of drying vanes 123 may distribute the drying air and guide the flow of the drying air in the width direction of the drying trunk intersecting the second direction F2.

Specifically, in some embodiments, the secondary battery manufacturing apparatus 100 may include the air supply duct 110 through which the drying air is guided to flow in the first direction F1. The air supply duct 110 may receive the drying air for drying the electrode 10 through a blower or the like. The supplied drying air may be guided to flow in the first direction F1 along the air supply duct 110. In other words, the air supply duct 110 may be formed to extend along the first direction F1. The first direction F1 may be formed as one direction in a plan view, and in the illustrated embodiment, the first direction F1 is exemplified as a direction from the right to the left along the x-axis direction

Meanwhile, in some embodiments, the secondary battery manufacturing apparatus 100 may include the drying trunk 120 connected to the air supply duct 110 so that the drying air is guided to flow in the second direction F2. The drying trunk 120 may be connected to an outlet of the air supply duct 110 and may receive the drying air from the air supply duct 110. The supplied drying air may be guided to flow in the second direction F2 along the drying trunk 120. In other words, the drying trunk 120 may be formed to extend along the second direction F2. Here, the second direction F2 may be formed as one direction in a plan view, and may be formed as a direction intersecting the first direction F1. For example, the second direction F2 may be formed as a direction orthogonal to the first direction F1 in a plan view. In the illustrated embodiment, the second direction F2 is exemplified as a direction from the front to back along the y-axis direction.

In some embodiments, the drying trunk 120 may supply the drying air to the electrode 10 therebelow. Specifically, the drying trunk 120 may be provided with a nozzle 130 on the bottom thereof, and may supply the drying air to the electrode 10 therebelow through the nozzle 130. The electrode 10 may be appropriately dried by the drying air provided from the nozzle 130 while being transported along the longitudinal direction (the front-back direction) under the drying trunk 120. The nozzle 130 may be formed to extend along a left-right width direction of the electrode 10 so as to cover the left-right width W1 of the electrode 10.

Meanwhile, in some embodiments, the air supply duct 110 may have the plurality of air supply flow paths 111. The plurality of air supply flow paths 111 may be partitioned by the plurality of air supply vanes 113 disposed in the air supply duct 110. Specifically, the air supply duct 110 may have a duct sidewall 112 on each of both sides in the width direction. For convenience of description, the duct sidewall 112 provided on one side of the sides in the width direction of the air supply duct 110 is referred to as a first duct sidewall 112a, and the duct sidewall 112 provided on an opposite side to correspond to the first duct sidewall 112a is referred to as a second duct sidewall 112b. The air supply duct 110 may have the plurality of air supply flow paths 111 between the first and second duct sidewalls 112a and 112b. Each air supply flow path 111 may be formed to extend along the first direction F1. In the illustrated embodiment, four air supply flow paths 111 are exemplified. Hereinafter, for convenience, the air supply flow paths 111 will be referred to as first to fourth air supply flow paths 111a to 111d, respectively.

The first air supply flow path 111a may be disposed adjacent to the first duct sidewall 112a and formed to extend along the first direction F1. Similarly, the fourth air supply flow path 111d may be disposed adjacent to the second duct sidewall 112b and formed to extend along the first direction F1. The second and third air supply flow paths 111b and 111c may be formed to extend along the first direction F1 between the first and fourth air supply flow paths 111a and 111d.

In some embodiments, the air supply duct 110 may have a certain width W2 between the first and second duct sidewalls 112a and 112b. Further, the plurality of air supply flow paths 111 may be formed to equally divide the width W2 of the air supply duct 110 in a default state. For example, in the illustrated embodiment, the widths of the first to fourth air supply flow paths 111a to 111d may be formed to be the same.

In some embodiments, the drying air introduced into the air supply duct 110 may be distributed and guided to flow through the plurality of air supply flow paths 111. That is, the drying air may be distributed and guided to flow in the width direction of the air supply duct 110 in the air supply duct 110.

Meanwhile, in some embodiments, the drying trunk 120 may include the plurality of drying flow paths 121. The plurality of drying flow paths 121 may be partitioned by the plurality of drying vanes 123 disposed in the drying trunk 120. Specifically, the drying trunk 120 may have a trunk sidewall 122 on each of both sides in the width direction. For convenience of description, the trunk sidewall 122 provided on one side of the sides in the width direction of the drying trunk 120 is referred to as a first trunk sidewall 122a, and the trunk sidewall 122 provided on an opposite side to correspond to the first trunk sidewall 122a is referred to as a second trunk sidewall 122b. The drying trunk 120 may have the plurality of drying flow paths 121 between the first and second trunk sidewalls 122a and 122b. Each drying flow path 121 may be formed to extend along the second direction F2. The plurality of drying flow paths 121 may be provided to correspond to the air supply flow paths 111. In the illustrated embodiment, four drying flow paths 121 are shown to correspond to the air supply flow paths 111. Hereinafter, for convenience, the drying flow paths 121 will be referred to as first to fourth drying flow paths 121a to 121d, respectively.

The first drying flow path 121a may be disposed adjacent to the first trunk sidewall 122a and formed to extend along the second direction F2. Similarly, the fourth drying flow path 121d may be disposed adjacent to the second trunk sidewall 122b and formed to extend along the second direction F2. The second and third drying flow paths 121b and 121c may be formed to extend along the second direction F2 between the first and fourth drying flow paths 121a and 121d. Further, each drying flow path 121 may be provided to be connected to the corresponding air supply flow path 111. That is, the first drying flow path 121a may be formed to be connected to the first air supply flow path 111a, and similarly, the second to fourth drying flow paths 121b to 121d may be formed to be respectively connected to the second to fourth air supply flow paths 111b to 111d.

In some embodiments, the drying trunk 120 may have a certain width W3 between the first and second trunk sidewalls 122a and 122b. Further, the plurality of drying flow paths 121 may be formed to equally divide the width W3 of the drying trunk 120. For example, in the illustrated embodiment, the widths of the first to fourth drying flow paths 121a to 121d may be formed to be the same.

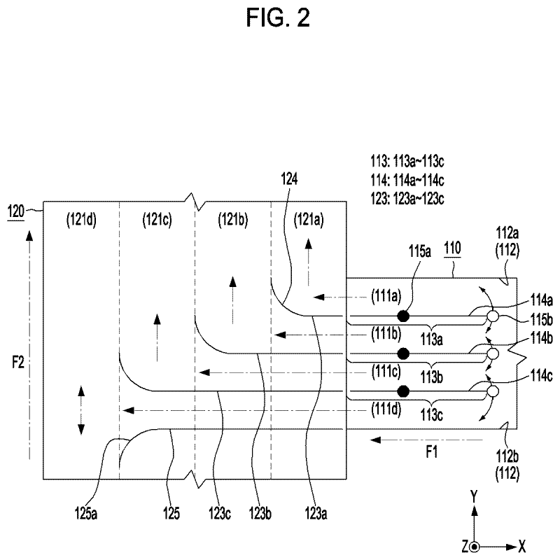

FIG. 2 is a partially enlarged view of the secondary battery manufacturing apparatus shown in FIG. 1.

Referring to FIG. 2, in some embodiments, the plurality of air supply vanes 113 which partition the plurality of air supply flow paths 111 may be provided inside the air supply duct 110. The illustrated embodiment exemplifies a case in which three air supply vanes 113 partition four air supply flow paths 111. Hereinafter, for convenience, the air supply vanes 113 will be referred to as first to third air supply vanes 113a to 113c, respectively.

The first air supply vane 113a is disposed at a certain interval from the first duct sidewall 112a in the y-axis direction to form the first air supply flow path 111a between the first air supply vane 113a and the first duct sidewall 112a. Similarly, the second air supply vane 113b is disposed at a certain interval from the first air supply vane 113a in the y-axis direction to form the second air supply flow path 111b between the second air supply vane 113b and the first air supply vane 113a, and the third air supply vane 113c is disposed at a certain interval from the second air supply vane 113b in the y-axis direction to form the third air supply flow path 111c between the third air supply vane 113c and the second air supply vane 113b. Further, the third air supply flow path 111c is spaced at a certain interval from the second duct sidewall 112b in the y-axis direction to form the fourth air supply flow path 111d between the third air supply flow path 111c and the second duct sidewall 112b.

Meanwhile, in some embodiments, the drying vane 123 which partitions the drying flow path 121 may be provided inside the drying trunk 120. The illustrated embodiment exemplifies a case in which three drying vanes 123 partition four drying flow paths 121. For reference, the vane disposed at the lowest end in the drawing is an edge vane 125 to be described below. Hereinafter, for convenience, the drying vanes 123 will be referred to as first to third drying vanes 123a to 123c, respectively.

In some embodiments, one end (a right end in the drawing) of the first drying vane 123a may be disposed to correspond to one end (a left end in the drawing) of the first air supply vane 113a. Accordingly, the first drying flow path 121a may form one flow path connected to the first air supply flow path 111a. The first drying vane 123a may be formed to extend a certain length from the one end into the drying trunk 120 in the x-axis direction. The first drying vane 123a may also include a first direction-changing portion 124 in an end region opposite to the one end and may be formed to extend in a curved manner in the y-axis direction. The first direction-changing portion 124 may be formed in a gently curved shape having an arc shape. Further, the first direction-changing portion 124 may extend so that the end thereof is disposed at a boundary of the first and second drying flow paths 121a and 121b. Accordingly, the first drying flow path 121a may be partitioned from the second drying flow path 121b.

Similarly to the above, the second drying vane 123b may extend from one end of the second air supply vane 113b into the drying trunk 120 in the x-axis direction. The second drying vane 123b may extend longer than the first drying vane 123a to guide the drying air into the second drying flow path 121b. Further, the second drying vane 123b may also include a first direction-changing portion in an end region and may extend in a curved manner in the y-axis direction. One end of the first direction-changing portion of the second drying vane 123b may be disposed at a boundary of the second and third drying flow paths 121b and 121c, and accordingly, the second drying flow path 121b may be partitioned from the third drying flow path 121c.

Further, the third drying vane 123c may extend from one end of the third air supply vane 113c into the drying trunk 120 in the x-axis direction. The third drying vane 123c may extend longer than the second drying vane 123b to guide the drying air into the third drying flow path 121c. Further, the third drying vane 123c may also include a first direction-changing portion in an end region and may extend in a curved manner in the y-axis direction. One end of the first direction-changing portion of the third drying vane 123c may be disposed at a boundary of the third and fourth drying flow paths 121c and 121d, and accordingly, the third drying flow path 121c may be partitioned from the fourth drying flow path 121d.

In some embodiments, the edge vane 125 may further be provided in the drying trunk 120. The edge vane 125 may extend from the second duct sidewall 112b into the drying trunk 120 in the x-axis direction. In the illustrated embodiment, the edge vane 125 extends to have the same length as the third drying vane 123c in the x-axis direction. The edge vane 125 may form a flow path between the edge vane 125 and the third drying vane 123c in the x-axis direction. The flow path between the edge vane 125 and the third drying vane 123c may function to guide the drying air supplied through the fourth air supply flow path 111d to the fourth drying flow path 121d.

In some embodiments, the edge vane 125 may include a second direction-changing portion 125a in an end region. The second direction-changing portion 125a may extend in a curved manner in the y-axis direction in the end region of the edge vane 125. Here, the second direction-changing portion 125a may extend in a curved manner in an opposite direction to the first direction-changing portions 124 of the first to third drying vanes 123a to 123c. That is, in the illustrated embodiment, the first direction-changing portion 124 may extend in a curved manner in a backward direction (upward in the drawing) along the y-axis direction, and the second direction-changing portion 125a may extend in a curved manner in a forward direction (downward in the drawing) along the y-axis direction. The edge vane 125 allows the drying air to be appropriately distributed to the fourth drying flow path 121d disposed relatively far from the air supply duct 110.

The above-described secondary battery manufacturing apparatus 100 may supply the drying air supplied to the air supply duct 110 again to the electrode 10 through the drying trunk 120. The drying air may be supplied to the electrode 10 through the nozzle 130 under the drying trunk 120 and used to dry the coated active material, and the like. The electrode 10 may be continuously dried while being transported in the y-axis direction under the nozzle 130.

In some embodiments, an internal flow path of the air supply duct 110 is partitioned into the plurality of air supply flow paths 111, and an internal flow path of the drying trunk 120 is also partitioned into a plurality of corresponding drying flow paths 121, and thus the secondary battery manufacturing apparatus 100 may evenly provide the drying air to the entire region of the electrode 10. Accordingly, the electrode 10 may be evenly dried over the entire area. That is, the drying deviation of the electrode 10 may be alleviated. Specifically, the plurality of drying flow paths 121 may be disposed in the left-right width direction of the electrode 10 to provide the drying air to the electrode 10 through the nozzle 130 in each region in the width direction. Accordingly, the drying deviation along the left-right width direction of the electrode 10 may be alleviated.

Meanwhile, in some embodiments, the first to third air supply vanes 113a to 113c may be formed to distribute a flow rate of the drying air with a deviation along the width direction of the electrode 10. Alternatively, the first to third air supply vanes 113a to 113c may be formed to distribute the flow rate of the drying air with a deviation along the width direction of the air supply duct 110. For example, the first to third air supply vanes 113a to 113c may be formed to distribute a relatively small amount of drying air to edge-side air supply flow paths 111a and 111d corresponding to the widthwise edges of the electrode 10. Alternatively, the first to third air supply vanes 113a to 113c may be formed to distribute a relatively small amount of drying air to the edge-side air supply flow paths 111a and 111d adjacent to the duct sidewall 112. That is, in the illustrated embodiment, the first to third air supply vanes 113a to 113c may be formed to distribute a relatively small amount of drying air to the first air supply flow path 111a adjacent to the first duct sidewall 112a, and the fourth air supply flow path 111d adjacent to the second duct sidewall 112b.

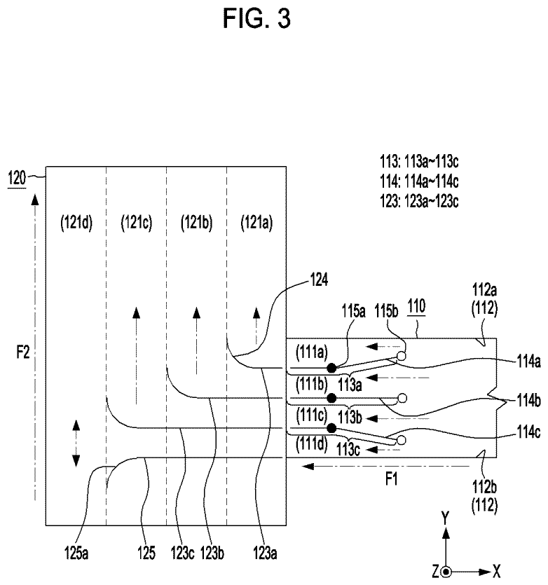

In some embodiments, the above-described flow rate distribution of the drying air may be implemented by varying an inlet size of each air supply flow path 111. For example, the edge-side air supply flow paths 111a and 111d corresponding to the widthwise edges of the electrode 10 may be formed with smaller inlet sizes than the other air supply flow paths 111b and 111c corresponding to the widthwise center region of the electrode 10. In other words, the edge-side air supply flow paths 111a and 111d adjacent to the duct sidewall 112 may be formed with smaller inlet sizes than the other air supply flow paths 111b and 111c disposed at the center (see FIG. 3). That is, in the illustrated embodiment, the first air supply flow path 111a adjacent to the first duct sidewall 112a and the fourth air supply flow path 111d adjacent to the second duct sidewall 112b may be formed with smaller inlet sizes than the second and third air supply flow paths 111b and 111c disposed at the center. The difference in inlet sizes allows a relatively small amount of drying air to be distributed to the corresponding first and fourth air supply flow paths 111a and 111d.

In some embodiments, the above-described flow rate distribution of the drying air may be achieved through a movable air supply vane 114. The movable air supply vane 114 may be provided on the air supply vane 113 to change an inlet width of the corresponding air supply flow path 111. In some embodiments, the movable air supply vane 114 may be provided to correspond to each air supply vane 113. In the illustrated embodiment, the movable air supply vane 114 is provided on each of the first to third air supply vanes 113a to 113c, and the movable air supply vanes 114 will be referred to as first to third movable air supply vanes 114a to 114c, respectively. The first movable air supply vane 114a may be disposed on the first air supply vane 113a, and similarly, the second and third movable air supply vanes 114b and 114c may be disposed on the second and third air supply vanes 113b and 113c, respectively.

The movable air supply vane 114 may be formed to move around a rotation axis 115a to change the inlet width of the corresponding air supply flow path 111. Describing the first movable air supply vane 114a as an example, the first movable air supply vane 114a may include the rotation axis 115a at one end (a left end in the drawing) in the x-axis direction and may extend in the longitudinal direction (the x-axis direction) from the rotation axis 115a. An opposite end portion (a right end in the drawing) of the first movable air supply vane 114a may include a movable end 115b movable in a circumferential direction around the rotation axis 115a. The first movable air supply vane 114a may change the inlet width of the first air supply flow path 111a by moving (rotating) the movable end 115b around the rotation axis 115a. For example, the first movable air supply vane 114a may be operated so that the movable end 115b moves counterclockwise around the rotation axis 115a to reduce the inlet width of the first air supply flow path 111a. Conversely, the first movable air supply vane 114a may be operated so that the movable end 115b moves clockwise around the rotation axis 115a to increase the inlet width of the first air supply flow path 111a.

In some embodiments, the movable air supply vane 114 may be connected to a driving unit. The movable air supply vane 114 may be moved to a certain rotational position by the driving unit or maintained at the certain rotational position. For example, the movable air supply vane 114 may be moved to the certain rotational position by an actuator linked to the movable end 115b or maintained at the certain rotational position.

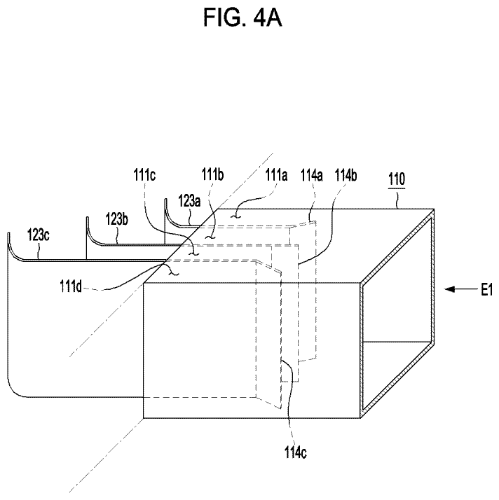

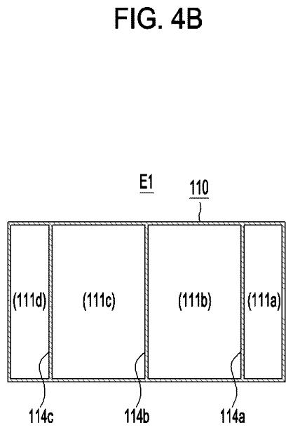

FIG. 3 is an exemplary operating state diagram of the secondary battery manufacturing apparatus shown in FIG. 1. FIG. 4A is a schematic diagram showing the operating state of an air supply duct shown in FIG. 3. FIG. 4B is a schematic diagram showing the air supply duct as seen in the direction of E1 in FIG. 4A.

Referring to FIGS. 3, 4A and 4B, in some operating examples, the first movable air supply vane 114a may be disposed to rotate a certain angle counterclockwise around the rotation axis 115a. Accordingly, the first air supply flow path 111a adjacent to the first duct sidewall 112a may be provided with a smaller inlet size than the second and third air supply flow paths 111b and 111c disposed at the center. Similarly, the third movable air supply vane 114c may be rotated a certain angle clockwise, and the fourth air supply flow path 111d may be provided with a smaller inlet size than the second and third air supply flow paths 111b and 111c.

In the above case, a relatively small amount of drying air may be distributed to the first air supply flow path 111a and the fourth air supply flow path 111d. That is, when a uniform flow rate of the drying air is provided in the width direction of the air supply duct 110, since the first air supply flow path 111a and the fourth air supply flow path 111d are formed with relatively small inlet sizes, a relatively small amount of drying air may be distributed. Accordingly, a relatively small amount of drying air may be distributed to the first drying flow path 121a connected to the first air supply flow path 111a and the fourth drying flow path 121d connected to the fourth air supply flow path 111d. In other words, a relatively small amount of drying air may be distributed to the edge-side air supply flow paths 111a and 111d adjacent to the duct sidewall 112, and accordingly, a relatively small amount of drying air may be distributed to the edge-side drying flow paths 121a and 121d adjacent to the trunk sidewall 122.

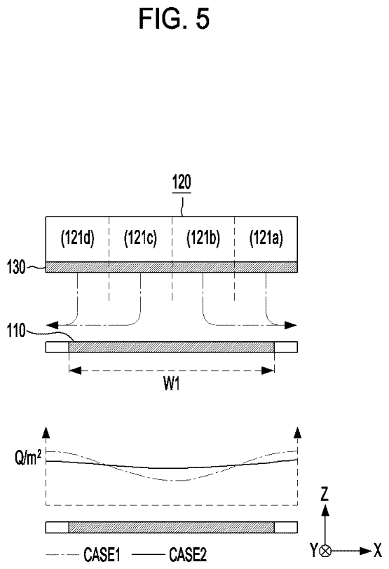

FIG. 5 is a schematic graph showing an amount of heat supply along the width direction of the electrode in the operating state shown in FIG. 3. In FIG. 5, a horizontal axis corresponds to the width direction of the electrode, and a vertical axis corresponds to the amount of heat supplied per unit area.

CASE 1 in FIG. 5 exemplifies a case in which the inlets of the first to fourth air supply flow paths 111a to 111d are set to the same size. In CASE 1, each air supply vane 113 may be generally disposed as shown in FIG. 1. In CASE 1, the drying air supplied to the air supply duct 110 may be equally distributed to the first to fourth air supply flow paths 111a to 111d. Further, the drying air distributed to the first to fourth air supply flow paths 111a to 111d may be introduced into the drying trunk 120 along the first direction F1 and may flow in the second direction F2 in the drying trunk 120. In addition, the drying air introduced into the drying trunk 120 may be supplied to the electrode 10 through the nozzle 130 at the bottom.

In the above case, the drying air supplied from the nozzle 130 toward the electrode 10 may be partially accumulated at left-right widthwise end portions of the electrode 10. That is, the drying air supplied to the electrode 10 generally may be accumulated in the widthwise end portion regions while flowing from the widthwise center of the electrode 10 to the widthwise end portions. Accordingly, over-drying may occur in the left-right widthwise end portions of the electrode 10, and this may cause surface defects such as cracks and the like.

The operating state shown in FIG. 3 may contribute to alleviating the over-drying of the above-described end portion regions. CASE 2 in FIG. 5 shows a case in which the inlets of the first to fourth air supply flow paths 111a to 111d are set to different sizes as exemplified in FIG. 3. In CASE 2, the first and fourth air supply flow paths 111a and 111d may be provided with smaller inlet sizes than the second and third air supply flow paths 111b and 111c. In CASE 2, a relatively small amount of drying air supplied to the air supply duct 110 may be distributed to the first and fourth air supply flow paths 111a and 111d and a relatively large amount thereof may be distributed to the second and third air supply flow paths 111b and 111c. The drying air distributed to the first to fourth air supply flow paths 111a to 111d may be introduced into the drying trunk 120 along the first direction F1 and flow in the second direction F2 in the drying trunk 120.

In the above case, a relatively small amount of drying air may be provided to the first and fourth drying flow paths 121a and 121d corresponding to the first and fourth air supply flow paths 111a and 111d. Further, an amount of drying air directly provided to the electrode 10 through the nozzle 130 may be relatively small in the left-right widthwise edge regions of the electrode 10. Thereafter, the drying air may be accumulated in the widthwise edge regions while flowing from the widthwise center of the electrode 10 to the widthwise edges. Accordingly, as a result, the electrode 10 may receive a more uniform amount of heat along the left-right width direction, and over-drying in the left-right widthwise edge regions may be alleviated.

However, in the embodiments according to the present disclosure, the operating state of the air supply flow paths 111a to 111d or the drying flow paths 121a to 121d are not necessarily limited to the above-exemplified operating state. The operating state of the air supply flow paths 111a to 111d or the drying flow paths 121a to 121d may be appropriately modified depending on the specifications, coating form, or the like of the electrode 10 to be dried, and may also be appropriately modified depending on the magnitude, intensity, or the like of the provided airflow. The secondary battery manufacturing apparatus 100 according to the embodiments of the present disclosure has one feature of being capable of adjusting the drying air flow rate in the air supply flow paths 111a to 111d or the drying flow paths 121a to 121d in various forms through the air supply vane 113 or the drying vane 123, and thus appropriately responding to various electrodes, process conditions, environments, and the like.

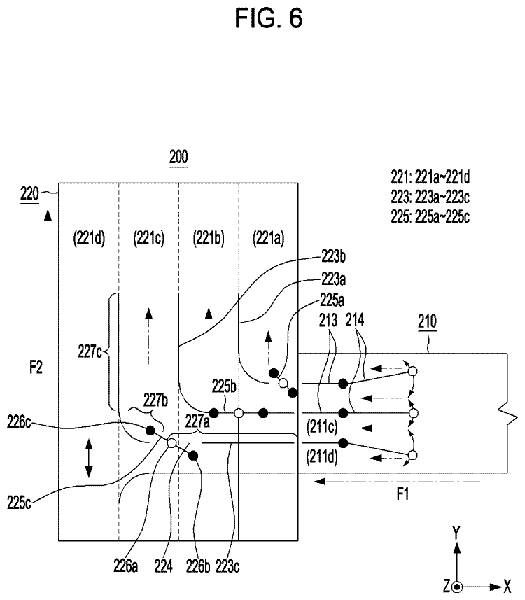

FIG. 6 is a conceptual diagram showing a secondary battery manufacturing apparatus according to another embodiment of the present disclosure.

Hereinafter, for convenience, differences from the above-mentioned embodiment will be mainly described.

Referring to FIG. 6, in the illustrated embodiment, a secondary battery manufacturing apparatus 200 may include an air supply duct 210 and a drying trunk 220. The air supply duct 210 may include a plurality of air supply vanes 213, and the drying trunk 220 may include a plurality of drying vanes 223. Further, each air supply vane 213 may include a movable air supply vane 214. A nozzle may be provided to supply drying air supplied to the drying trunk 220 to an electrode at the bottom thereof. In the illustrated embodiment, the air supply duct 210 and the nozzle may be provided substantially the same as or similar to the above-described embodiments.

Meanwhile, a plurality of drying vanes 223 may be provided, and the plurality of drying vanes 223 may partition an internal flow path of the drying trunk 220 into a plurality of drying flow paths 221. In the illustrated embodiment, the drying vanes 223 are exemplified as first to third drying vanes 223a to 223c, and the drying flow paths 221 are exemplified as first to fourth drying flow paths 221a to 221d.

In some embodiments, the drying vane 223 may include an opening 224. In the illustrated embodiment, the opening 224 is provided in each of the first to third drying vanes 223a to 223c. The openings 224 may be formed to pass through the drying vanes 223 to connect adjacent drying flow paths 221. Describing the third drying vane 223c as an example, the opening 224 may be formed to pass through the third drying vane 223c to connect the third drying flow path 221c and the fourth drying flow path 221d. Similarly, an opening which connects the second and third drying flow paths 221b and 221c may be formed in the second drying vane 223b, and an opening which connects the first and second drying flow paths 221a and 221b may be formed in the first drying vane 223a. The openings 224 allow the drying air to be redistributed between adjacent drying flow paths 221.

In some embodiments, the opening 224 may include a movable drying vane 225. In the illustrated embodiment, the movable drying vane 225 is provided in the opening of each of the first to third drying vanes 223a to 223c. Hereinafter, for convenience, the movable drying vanes 225 will be referred to as first to third movable drying vanes 225a to 225c, respectively.

In some embodiments, the movable drying vane 225 may be provided to adjust an opening degree of the opening 224. That is, an open area of the opening 224 may be adjusted according to the operation of the movable drying vane 225. Describing the third movable drying vane 225c as an example, the opening 224 may be closed or opened according to the operation of the third movable drying vane 225c, and when the opening 224 is open, an open area may be adjusted according to an arrangement state of the third movable drying vane 225c.

In some embodiments, the opening degree of the movable drying vane 225 may be adjusted as the movable drying vane 225 rotates around a rotation axis 226a. Describing the third movable drying vane 225c as an example, the third movable drying vane 225c may be disposed in the opening 224 and provided to rotate around the rotation axis 226a at a center thereof. Further, the third movable drying vane 225c may include first and second movable ends 226b and 226c with the rotation axis 226a therebetween. As the third movable drying vane 225c rotates around the rotation axis 226a, the first and second movable ends 226b and 226c may move to adjust the opening degree of the opening 224.

The movable drying vane 225 may function to distribute a flow rate of drying air between adjacent drying flow paths 221. Describing the third movable drying vane 225c as an example, the third movable drying vane 225c may adjust the opening degree of the opening 224 according to a rotational position around the rotation axis 226a, and the flow rate of drying air may be distributed between the third and fourth drying flow paths 221c and 221d according to the adjusted opening degree. In some cases, the third movable drying vane 225c may set a direction of flow rate distribution according to a rotating direction around the rotation axis 226a.

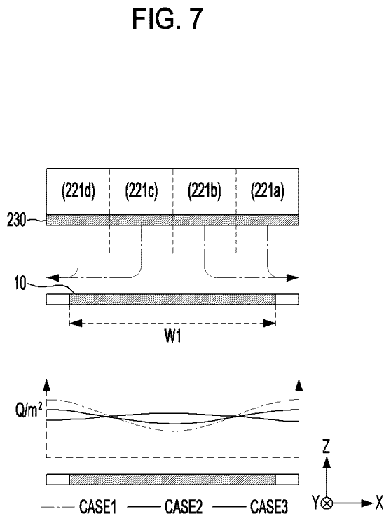

For example, the third movable drying vane 225c shown in FIG. 7 is disposed to rotate a certain angle clockwise around the rotation axis 226a in an initial state of being disposed parallel to the third drying vane 223c. The third movable drying vane 225c disposed in this way may function to distribute some of the drying air introduced through the fourth air supply flow path 211d to the third drying flow path 221c and distribute the remaining drying air to the fourth drying flow path 221d. That is, the third movable drying vane 225c may function to secondarily distribute the drying air primarily distributed in the air supply duct 210 in the drying trunk 220.

Although not shown, the above-described third movable drying vane 225c may also implement distribution in an opposite direction or the like through a rotational arrangement state. For example, when it is assumed that the third movable drying vane 225c is disposed to rotate a certain angle counterclockwise around the rotation axis 226a in an initial state, the third movable drying vane 225c may function to distribute some of the drying air introduced through the third air supply flow path 211c to the fourth drying flow path 221d. Each movable drying vane 225c may efficiently implement flow rate distribution in various situations in this way.

Meanwhile, in some embodiments, the drying vane 223 may be formed to extend a little longer along a movement direction of the electrode unlike the above-described embodiment. Describing the third drying vane 223c as an example, the third drying vane 223c may include a first extending portion 227a, a first direction-changing portion 227b, and a second extending portion 227c along a longitudinal direction. The first extending portion 227a may be formed to extend along a width direction of the drying trunk 220. Further, the first direction-changing portion 227b may be formed to extend in a curved manner in a second direction F2 from an end portion (a left end in the drawing) of the first extending portion 227a. The second direction F2 corresponds to a traveling direction of the electrode. Further, the second extending portion 227c may be formed to extend in a backward direction along the second direction F2 from an end portion (an upper end in the drawing) of the first direction-changing portion 227b. That is, the second extending portion 227c may be formed to extend a certain length along the traveling direction of the electrode. Meanwhile, although the third drying vane 223c is described as an example, the first and second drying vanes 223b and 223c may also be formed in the same or similar manner.

The above-described drying vane 223 may induce a more uniform laminar flow in the first to fourth drying flow paths 221a to 221d. Accordingly, a drying deviation in each region of the electrode may be further alleviated.

In some embodiments, the above-described movable drying vane 225 may be disposed in the first extending portion 227a of the drying vane 223. That is, the movable drying vane 225 may be disposed at a position before the flowing direction of the drying air is changed. This arrangement may contribute to reducing the influence of the flow rate distribution by the movable drying vane 225 on the drying air flow at a rear end.

In some embodiments, the movable drying vane 225 may be disposed at a position adjacent to the end portion (the left end in the drawing) of the first extending portion 227a to be disposed adjacent to the first direction-changing portion 227b. This arrangement allows the distributed flow rate to be directly introduced into the drying flow path 221 in the second direction F2 after the flow rate distribution by the movable drying vane 225 is performed. This may contribute to suppressing the occurrence of vortices due to the flow rate distribution. Describing the third movable drying vane 225c as an example, in the illustrated state, the drying air introduced through the opening 224 between the first movable end 226b and the third drying vane 223c may flow in a roughly diagonal direction and may be introduced into the third drying flow path 221c. Further, the introduced drying air may be guided to flow in the second direction F2 directly through the first direction-changing portion 227b and may be quickly formed into a uniform flow while moving along the second extending portion 227c.

FIG. 7 is a schematic graph showing an amount of heat supply along the width direction of the electrode in the secondary battery manufacturing apparatus shown in FIG. 6.

FIG. 7 shows the amount of heat supply along the width direction of the electrode 10 when the drying air distribution method of FIG. 6 is added to drying air inflow control method of FIG. 3. CASE 1 and 2 in FIG. 7 correspond to the above-described CASE 1 and 2 in FIG. 3, and CASE 3 shows a case in which the drying air distribution method of FIG. 6 is added. In CASE 3, the drying air may be redistributed to each flow path while the flow rate of the drying air is primarily controlled as in CASE 2 to make the amount of heat transferred in the left-right width direction of the electrode 10 more uniform.

Meanwhile, according to another aspect of the present disclosure, a secondary battery manufacturing method may be provided. In some embodiments, the secondary battery manufacturing method may be implemented using the secondary battery manufacturing apparatus of the above-described embodiments.

Referring to FIG. 1, in some embodiments, the secondary battery manufacturing method may include: (a) an operation of guiding drying air to flow through an air supply duct 110 in a first direction F1; (b) an operation of guiding the drying air to flow through a drying trunk 120 in a second direction F2 intersecting the first direction F1; and (c) an operation of supplying the drying air to an electrode 10 traveling in the second direction F2. Here, operation (a) may include an operation in which a plurality of air supply flow paths 115 are partitioned in a width direction of the air supply duct 110 intersecting the first direction F1, and the drying air is distributed and guided to flow into a plurality of air supply flow paths 111. Further, operation (b) may include an operation in which a plurality of drying flow paths 121 are partitioned in the width direction of the drying trunk 120 intersecting the second direction F2, and the drying air is distributed and guided to flow into the plurality of drying flow paths 121.

In addition, in some embodiments, operation (a) may include an operation of distributing a relatively small amount of drying air to edge-side air supply flow paths 111a and 111d adjacent to a duct sidewall 112 of the air supply duct 110. For example, operation (a) may be performed to distribute a relatively small amount of drying air to the first and fourth air supply flow paths 111a and 111d. Further, operation (b) may include an operation of distributing a relatively small amount of drying air to edge-side drying flow paths 121a and 121d adjacent to a trunk sidewall 122 of the drying trunk 120 according to the distribution of the drying air. For example, operation (b) may be performed to distribute a relatively small amount of drying air to the first and fourth drying flow paths 121a and 121d. Such flow distribution may be induced through the flow rate distribution in operation (a).

Since the above-described actions and effects of the secondary battery manufacturing method have been described through the secondary battery manufacturing apparatus 100 of the above-described embodiments, overlapping description will be omitted.

As described above, the embodiments of the present disclosure may provide a secondary battery manufacturing apparatus and method. The secondary battery manufacturing apparatus and method according to the embodiments may be appropriately used in an electrode drying process.

In at least some embodiments of the present disclosure, the drying air may be evenly provided to the entire area of the electrode through partition of the flow paths of the air supply duct and drying trunk. Accordingly, the drying deviation for each region of the electrode may be alleviated, and processing quality may be improved and manufacturing costs may be reduced.

Further, at least some embodiments of the present disclosure may alleviate the drying deviation along the left-right width direction of the electrode. In addition, the over-drying in the left-right widthwise end regions of the electrode may be prevented.

In addition, at least some embodiments of the present disclosure may appropriately adjust the flow rate of drying air for each region of the electrode. For example, the flow rate of drying air supplied to each region may be appropriately adjusted depending on the type, specifications, thickness, or the like of the electrode. Accordingly, the secondary battery manufacturing apparatus and method according to the embodiments may be widely utilized in various electrode drying processes.

Further, at least some embodiments of the present disclosure may be implemented with relatively low equipment costs. In some cases, the secondary battery manufacturing apparatus and method according to the embodiments may be implemented through a partial change or replacement of the air supply duct or the drying trunk. Accordingly, the secondary battery manufacturing apparatus and method according to the embodiments may implement improvements in processing quality or the like in a cost-effective manner.

Some embodiments of the present disclosure can provide a secondary battery manufacturing apparatus and method which can be used to dry an electrode.

Further, some embodiments of the present disclosure can provide a secondary battery manufacturing apparatus and method capable of improving processing quality of an electrode and reducing manufacturing costs.

The above description is only an example to which the principle of the present disclosure is applied, and other configurations may be further included without departing from the scope of the present disclosure.

What is claimed is:

1. A secondary battery manufacturing apparatus comprising:
an air supply duct that guides a flow of drying air in a first direction; and
a drying trunk connected to the air supply duct to guide the flow of the drying air in a second direction intersecting the first direction and supply the drying air to an electrode at a bottom thereof,
wherein the air supply duct includes a plurality of air supply vanes that partition a plurality of air supply flow paths,
the drying trunk includes a plurality of drying vanes that partition a plurality of drying flow paths to correspond to the plurality of air supply flow paths,
the plurality of air supply vanes distribute the drying air and guide the flow of the drying air in a width direction of the air supply duct intersecting the first direction, and
the plurality of drying vanes distribute the drying air and guide the flow of the drying air in a width direction of the drying trunk intersecting the second direction.

2. The secondary battery manufacturing apparatus of claim 1, wherein the plurality of air supply vanes are formed to distribute a flow rate of the drying air with a deviation along the width direction of the air supply duct.

3. The secondary battery manufacturing apparatus of claim 1, wherein the plurality of air supply vanes are formed to distribute a relatively small amount of the drying air to an edge-side air supply flow path corresponding to a widthwise edge of the electrode.

4. The secondary battery manufacturing apparatus of claim 1, wherein the plurality of air supply flow paths include an edge-side air supply flow path corresponding to a widthwise edge of the electrode, and
the edge-side air supply flow path is formed with a smaller inlet size than an air supply flow path disposed at a center.

5. The secondary battery manufacturing apparatus of claim 1, wherein one or more of the plurality of air supply vanes include a movable air supply vane formed to change an inlet width of the corresponding air supply flow path.

6. The secondary battery manufacturing apparatus of claim 5, wherein the movable air supply vane is formed to change the inlet width of the air supply flow path by moving a movable end in a circumferential direction around a rotation axis.

7. The secondary battery manufacturing apparatus of claim 1, wherein the electrode is dried under the drying trunk while traveling in the second direction.

8. The secondary battery manufacturing apparatus of claim 1, wherein each of the plurality of drying vanes is formed to extend a certain length from the corresponding air supply vane in the width direction of the drying trunk.

9. The secondary battery manufacturing apparatus of claim 8, wherein the plurality of drying vanes are formed to extend to have different lengths in the width direction of the drying trunk, and
the plurality of drying flow paths are partitioned by the plurality of drying vanes to have the same width in the width direction of the drying trunk.

10. The secondary battery manufacturing apparatus of claim 8, wherein one or more of the plurality of drying vanes include a first direction-changing portion at an end portion, and
the first direction-changing portion changes the direction of the drying air guided to flow in the width direction of the drying trunk to the second direction and guides the flow.

11. The secondary battery manufacturing apparatus of claim 8, comprising an edge vane formed to extend from one side duct sidewall of the air supply duct in the width direction of the drying trunk,
wherein each of the plurality of drying vanes includes a first direction-changing portion at an end portion,
the first direction-changing portion extends in a curved manner in a backward direction along the second direction,
the edge vane includes a second direction-changing portion at an end portion, and
the second direction-changing portion extends in a curved manner in a forward direction along the second direction.

12. The secondary battery manufacturing apparatus of claim 1, wherein one or more of the plurality of drying vanes include an opening that connects adjacent drying flow paths, and
the opening includes a movable drying vane that adjusts an opening degree of the opening.

13. The secondary battery manufacturing apparatus of claim 12, wherein the movable drying vane includes first and second movable ends disposed with a rotation axis therebetween and is formed so that the first and second movable ends move and change the opening degree of the opening as the movable drying vane is rotated around the rotation axis.

14. The secondary battery manufacturing apparatus of claim 12, wherein the movable drying vane is formed to adjust the opening degree of the opening and distribute a flow rate of the drying air between the adjacent drying flow paths.

15. The secondary battery manufacturing apparatus of claim 12, wherein each of the drying vanes includes:
a first extending portion extending in the width direction of the drying trunk;
a first direction-changing portion extending in a curved manner from an end portion of the first extending portion to change the direction of the drying air to the second direction; and
a second extending portion formed to extend from an end portion of the first direction-changing portion in a backward direction along the second direction.

16. The secondary battery manufacturing apparatus of claim 15, wherein the movable drying vane is disposed in the first extending portion of the corresponding drying vane.

17. A secondary battery manufacturing method comprising:
(a) an operation of guiding drying air to flow through an air supply duct in a first direction;
(b) an operation of guiding the drying air to flow through a drying trunk in a second direction intersecting the first direction; and
(c) an operation of supplying the drying air to an electrode traveling in the second direction,
wherein operation (a) includes an operation in which a plurality of air supply flow paths are partitioned in a width direction of the air supply duct intersecting the first direction, and the drying air is distributed and guided to flow into the plurality of air supply flow paths, and
operation (b) includes an operation in which a plurality of drying flow paths are partitioned in a width direction of the drying trunk intersecting the second direction, and the drying air is distributed and guided to flow into the plurality of drying flow paths.

18. The secondary battery manufacturing method of claim 17, wherein operation (a) includes distributing a relatively small amount of the drying air to an edge-side air supply flow path corresponding to a widthwise edge of the electrode, and
operation (b) includes distributing a relatively small amount of the drying air to an edge-side drying flow path corresponding to a widthwise edge of the electrode according to the distribution of the drying air.

19. The secondary battery manufacturing method of claim 17, wherein the air supply duct includes a plurality of air supply vanes that partition the plurality of air supply flow paths, and
one or more of the plurality of air supply vanes include a movable air supply vane formed to change an inlet width of the corresponding air supply flow path.

20. The secondary battery manufacturing method of claim 17, wherein the drying trunk includes a plurality of drying vanes that partition the plurality of drying flow path, and
one or more of the plurality of drying vanes includes a movable drying vane formed to distribute a flow rate of the drying air between adjacent drying flow paths.
